(19) United States
(12) Patent Application Publication
(10) Pub. No.: US 2008/0163946 A1
(43) Pub. Date: Jul. 10, 2008

(54) MAGNETICALLY CONTROLLED VALVE FOR FLOW MANIPULATION IN POLYMER MICROFLUIDIC DEVICES

(75) Inventors: Frank A. Gomez, Montebello, CA (US); Attila Gaspar, Debrecen (HU); Menake E. Piyasena, Silver Spring, MD (US)

Correspondence Address: MASTERMIND IP LAW PC, 421-A SANTA MARINA COURT, ESCONDIDO, CA, 92029, US

(73) Assignee: The Trustees of California State University, Los Angeles, CA (US)

(21) Appl. No.: 11/966,958

(22) Filed: Dec. 28, 2007

Related U.S. Application Data
(60) Provisional application No. 60/882,379, filed on Dec. 28, 2006.

(51) Int. Cl. F16K 15/14; F16K 31/06

(52) U.S. Cl. 137/843; 251/129.01

(57) ABSTRACT

A simple, external in-line valve for use in microfluidic devices constructed of elastomer such as polydimethylsiloxane (PDMS) is described. The actuation of the valve is based on the principle that flexible polymer walls of a liquid channel can be pressed together by the aid of a permanent magnet and a small metal bar. In the presence of a small NdFeB magnet lying below the channel of interest, the metal bar is pulled downward simultaneously pushing the thin layer of PDMS down thereby closing the channel stopping any flow of fluid. The operation of the valve is dependent on the thickness of the PDMS layer, the height of the channel, the gap between the chip and the magnet and the strength of the magnet. The microfluidic channels are completely closed to fluid flows commonly used in microfluidic applications. The valve allows for fabrication of a “thin chip” that allows for detection of chromophoric species within the microchannel via an external fiber optics detection system. C18-Modified reverse phase silica particles are packed into the microchannel using a temporary taper created by the magnetic valve and separations using both pressure and electrochromatographic driven methods is detailed.

Support from the National Science Foundation (CHE-0515363 and DMR-0351848), the National Institutes if Health (1R15AI65468-01) and the European Community for the Marie Curie Fellowship (MOIF-CT-2006-021447) of A. Gaspar at California State University, Los Angeles is acknowledged.

### BACKGROUND

This application claims priority to U.S. application Ser. No. 60/882,379 filed on Dec. 28, 2006, and is incorporated herein in its entirety.

Microfluidic devices (MDs) have emerged as novel analytical tools in many areas of science and industry. Their inherent qualities including low power requirements, low sample consumption, rapid and parallel analysis, and automation provide unique opportunities to create novel and more powerful devices with a myriad of applications. In recent years polydimethylsiloxane (PDMS) has been widely used for microfluidic, optical, and nanoelectromechanical structures and in low-cost replication processes such as replica molding and templating.

The research on microfluidics has paid much attention to the development of the microfluidic components, i.e., micropumps, micromixers, world-to-chip microfluidic interfaces and microvalves. One of the most important elements of a successful miniaturized device is reliable microvalves since they make possible the manipulation of liquid flow in the channels, on/off switching of fluid flow, and injection of minute volumes of solution into the separation channel. To address the issue of sample loading and manipulation, a number of valve-type techniques have been developed.

Recently, another technique employing microvalves was proposed and demonstrated. In this technique, called multilayer soft lithography (MSL), they combined soft lithography with the capability to bond multiple patterned layers of elastomer. Layered structures are constructed by binding layers of elastomer, each of which is separately cast from a micromachined mold. The elastomer is made up of a two-component silicone wafer. The bottom layer (fluid or flow channels) has an excess of one of the monomers, whereas the upper layer (control channels) has an excess of the other monomer. The upper layer is removed from its mold and is placed on top of the lower layer, forming an irreversible seal due to reactive molecules at the interface between the two layers. When air is passed through the control channel, the fluid channel is pressed and a valve is formed.

Still, other types of microvalves have been developed. Microvalves have been classified as active or passive microvalves, employing mechanical, non-mechanical and external systems. In the mechanical microvalves, the mechanically movable membranes are connected to magnetic, electric, piezoelectric, and like means; whereas in the non-mechanical microvalves, the movable membranes are actuated by phase change or rheological materials. The external microvalves can be operated by external systems, e.g., pneumatic systems.

Among the numerous microvalves, some magnetically controlled microvalves have been detailed. For example, miniaturized electromagnetic microvalves were first developed for gas chromatography. Later, movable silicon membranes were integrated with solenoid coils or mounted with permanent magnets for glaucoma implants. Others used a micro ball valve in polymer tubing driven by an external solenoid using a metal bar with diameters of 760 μm and 3 mm. Others created magnetic layers of elastomer by loaded fine iron powder (20% or 50% by weight), or fabricated electromagnets with micron-scale dimension into PDMS chips. Another microvalve consists of an integrated inductor, deflectable silicon membrane with a NiFe thin film and a stationary inlet/outlet valve seat. In this system the leakage flow rates were several μL/min in the kPa range. The magnetic microvalves developed to date have not been applied in microfluidic lab-on-a-chip devices, where channels of only a few tens of microns could be closed/opened without leakage at flow rates in the μL/min range. A common disadvantage of many of these methods is that they all integrate either an electromagnet or contain a metal part of the valve on a movable membrane which prevents the chips from being disposable.

### SUMMARY OF THE INVENTION

The present invention provides a simple, external in-line valve for manipulation of fluid flow in microfluidic channels. The actuation of this valve is based upon the principle that flexible polymer walls in a liquid channel can be pressed together by the aid of magnets, thereby opening and closing the microfluidic channels. The valve can be integrated into various biochemical applications, including point-of-care diagnostics, bioterrorism detection, and drug discovery microfluidic devices. Potential applications include biotechnology, pharmaceuticals, life sciences, defense, public health and agriculture. One application allows for the fabrication of a chip-based electrochromatographic analysis system in which sample injection, separation and direct UV detection are easily performed. The simplicity of replication of the elastomeric chips and the minimal consumption of the conventional packing particles (tens of nanograms for a 10 mm length of packing) make the chips inexpensive and disposable. Since reversed-phase silica particles are widely used as the stationary phase in HPLC and SPE, the described chip-based electrochromatographic system has great potential in many applications (e.g., preconcentration and purification). The high flow-resistance of the packing reduces common injection problems found in chip-based analysis.

### BRIEF DESCRIPTION OF THE DRAWINGS

FIG. 1 (a-d). Sequential fabrication of the magnetically controlled microchip device. The vertical cross-section of the layers is not to scale.

FIG. 2. Photograph of a dismantled (a) and an assembled (b) fabricated microfluidic chip with a simple cross channel pattern magnetically controllable in two side channels and cross section (c) of the valve in operation.

FIG. 3. Schematic description of the opening and closure of the magnetically controlled microchip.

FIG. 4. Microscopic photograph of deformation of a thin PDMS layer (d=30 μm) due to the movement of metal bar toward the approaching magnet monitored under microscope. The distance between the magnet and the PDMS layer is 2 mm; the deformation is 7 mm.

FIG. 5. Plot of extent of deformation of a thin PDMS layer (d=30 μm) versus the distance between the magnet and the layer.

FIG. 6. Plot of extent of deformation of PDMS layers of varying thickness.

FIG. 7. Microscopic photographs detailing the operation of the magnetically controlled valve in a cross intersection. (a) Water and dye are pumped into the channels (fluid rate equal to 0.5 μL/min); (b) right side of the channel is opened); (c) bottom channel is magnetically controlled.

FIG. 8. Plot of the degree of the opening of the magnetically controlled valve versus increasing flow rate (pressure) in the chip.

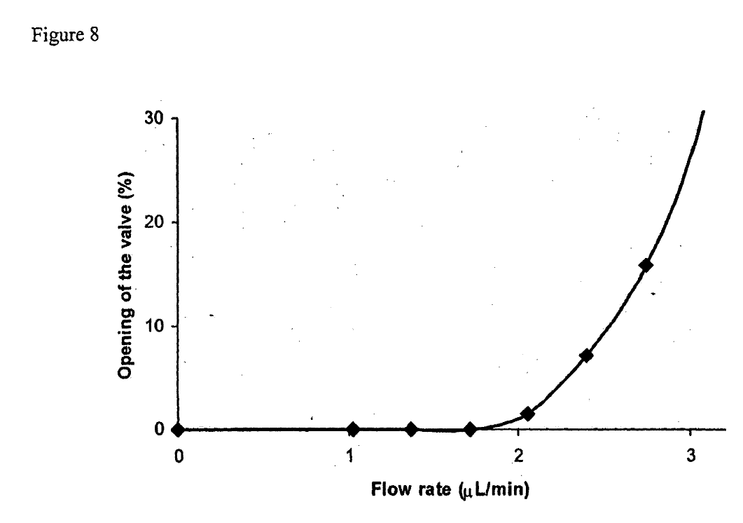

FIG. 9. Plot of spectrophotometrically monitored sequential injection of dye as absorbance versus time in a simple T-cross type chip using magnetically controlled valve with manual operation. The dye plugs were externally monitored at 410 nm.

FIG. 10. Microscopic photographs of a channel in front of a magnetic valve where 10 μm chromatographic beads are trapped (channel width: 100 μm).

FIG. 11. (A) Schematic illustration of the packing of a microchannel in a PDMS chip through pressing the top of the flexible PDMS chip to trap the chromatographic beads (not to scale; I, sample inlet; O, separation outlet; OR1 and OR2 are outlet reservoirs; the suspension of particles is pumped from O). (B) Optical micrograph of the fluid channel in front of the tapering after the pumping of the suspension of C18 particles. (C) Optical micrograph of C18 beads packed into a microchannel.

FIG. 12. Microscopic photographs of a separation channel using C18 packing of a PDMS chip during pressure injection (A, B) and CEC Separation (C-F).

FIG. 13. Separation of cephalosporin antibiotics in a chip packed with C18 modified silica particles in LC (A) and CEC (B) modes.

FIG. 14. Optical micographs comparing the separation of yellow and blue dyes in a chip packed with C18 modified silica particles in (A-C) LC and (D-F) CEC modes. (λ=265 mn, carrier: 50 mM phosphate, pH=6.8, voltage was 750 V during CEC, flow rate (in the separation channel) was 0.4 nL/s during LC).

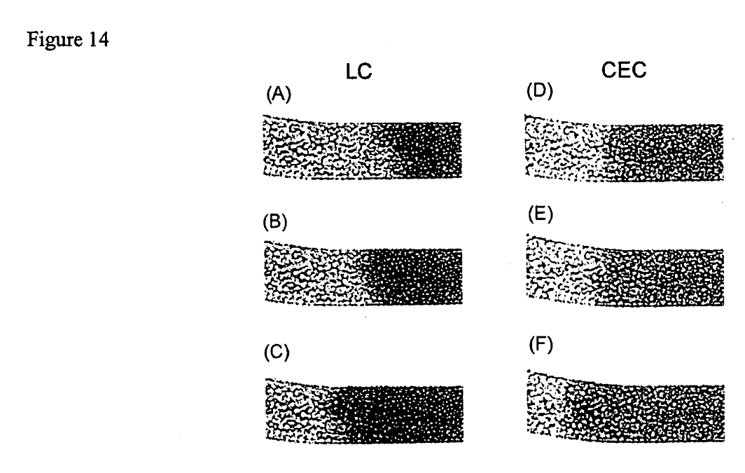

### DETAILED DESCRIPTION

Throughout this specification, the terms “a” and “an” and variations thereof represent the phrase “at least one.” In all cases, the terms “comprising”, “comprises” and any variations thereof should not be interpreted as being limitative to the elements listed thereafter. Unless otherwise specified in the description, all words used herein carry their common meaning as understood by a person having ordinary skill in the art. In cases where examples are listed, it is to be understood that combinations of any of the alternative examples are also envisioned. The scope of the invention is not to be limited to the particular embodiments disclosed herein, which serve merely as examples representative of the limitations recited in the issued claims resulting from this application, and the equivalents of those limitations.

A novel form of microvalve actuation employing one or more magnets for fluid manipulation in a microfluidic device is contemplated. Instead of using pressure, vacuum, thermal or electrical systems to control the valves, a small, NdFeB magnet is placed beside one section of an elastomeric microfluidic channel opposite a metal object located on the other side of the channel. The microfluidic channels can be completely closed in flow rates commonly used in microfluidic systems, including, but not limited to those ranging from 0.1-1.0 μL/min, for example. The moving part of the valve is itself the elastomeric wall of the channel opposing the magnet, hence, this technique yields zero dead-volume.

Since the magnetic valve does not require pumps, a high voltage power supply or other components, as in the case of other microfluidic valve systems, the magnetically controlled valve-based chips can be readily portable for injection and fluid manipulation. In addition, since the magnetic valve operates externally (without any internal manipulation, integration of wires, electrodes or other units), chips made from elastomers can be easily manufactured at low cost and are disposable.

The microfluidic chip includes at least two elastomeric layers stacked to each other and then sealed onto a thin support, such as a microscope cover glass. Types of elastomers include, but are not limited to polydimethylsiloxane (PDMS), poly(methyl methacrylate) (PMMA), polyether imide (PEI) and polyethylenimine, for example. PDMS is frequently used for microfluidic technologies. It is inert, non-toxic, and non-flammable. It is viscoelastic and has a shear modulus of between 100 kPa to 3 MPa. Other appropriate elastomers would be readily apparent to any person having ordinary skill in the art. An upper elastomer layer is used to hold the metal object and liquid connections (and electrode connections, if needed). A lower layer (membrane) contains the microfluidic channels, and it can be fabricated by using a mold, for example. The mold can have one or more fluid channels created by photolithography, for example. In one embodiment, the upper layer may be thicker than the lower layer. Appropriate thicknesses can be achieved, for example, by spin coating elastomer onto a mold. Thicker layers may be fabricated by simple pouring, for example into a petri dish. Elastomers can be baked and then peeled off from their supports.

Recently, “thin chips” have been designed using PDMS. The chip is roughly 100-125 μm in height and follows the same basic design as otherwise disclosed herein, namely, a layer on a support, a layer containing flow channel(s) and a top layer, all chemically bonded together. Unlike thicker PDMS chips that suffer from lack of sensitivity due to PDMS absorption in the visible and UV range, the thinness of these chips allows for detection of chromophoric species within the microchannel via an external fiber optics detection system. C18-modified reverse phase silica particles may be packed into the microchannel using a temporary taper created by a magnetic valve, for example, and separations using both pressure and electrochromatographic driven methods may be performed. Packed bed chromatography is one area of separations that is amenable to microfluidics-based techniques. Reversed-phase silica particles (e.g., C18), for example, are widely used as the stationary phase in high performance liquid chromatography (HPLC) and solid phase extraction (SPE) for preconcentration and separation of analytes or to remove unwanted components from samples. The packing of the silica beads into the microchips is made possible by the hydrophobic nature and elasticity of the elastomer.

Different retaining and stabilizing effects appearing in the packed channel have been observed. When pressures of approximately two bar are intermittently applied to compress the packing, the wall of the channel is deformed (extended). During this period, the particles fill the enlarged volume of the channel and the channel shrinks when the pressure is released thereby forming a continuous strain around the packing. The particles of the packing are pressed together by the forces of the elastic strains acting perpendicularly from the wall toward the middle of the channel (clamping-effect). Finally, these forces derived from elastic strain clamp the whole packing into the microfluidic channel. The stability of the packing is also due to the strong particle-wall interactions between the C18 modified silica and the hydrophobic surface of the PDMS chip. Particles adjacent to the elastomer wall deform and partly penetrate the wall, acting as anchors for the packing (anchor-effect). The presence of the high-flow resistance packing in the separation channel of chips packed with chromatographic particles spontaneously solved several injection problems well-known in microfluidics technology. The sample injection method used in this work utilizes hydrodynamic pressure, thereby, reducing the propensity for sample bias during the injection.

A single-channel peristaltic pump may be used for the injection, for example. The sample may be injected at the sample inlet port and manipulated into the other three channels with different flow rates depending on the hydraulic resistance of each channel. Due to the high hydraulic resistance of the packing, a largely reduced flow is observed in the separation channel, permitting the injection of a small sample plug of solution of only a few nanoliters into the separation channel. Because the hydraulic resistance in the separation channel of the chip is estimated to be approximately one thousand times higher (that is the flow rate is one thousand times smaller) than in the other channels, when one microliter of sample is injected into the chip with the peristaltic pump, only about one nanoliter is injected into the separation channel; the majority of the sample solution flows to the waste outlet reservoir and the buffer inlet. The sample volume injected into the separation channel is determined by the sample volume that is previously introduced into the pump tubing connected to the sample inlet port of the chip. The speed of the pumping solution has no influence on the amount of sample injected into the separation channel since the ratio of the flow rates toward the outlet ports is constant. Pumping at a higher rate only shortens the duration of the injection, but the volume of sample injected remains the same. The volume of the sample plug injected into the separation channel can be determined by monitoring the plug leaving the junction (this can be monitored microscopically using a colored sample plug). It is not mandatory to know the exact amount of solution injected, since the analysis is based on a relative calibration. Electrokinetic injections are biased, making it difficult to determine the exact amount of sample volume injected.

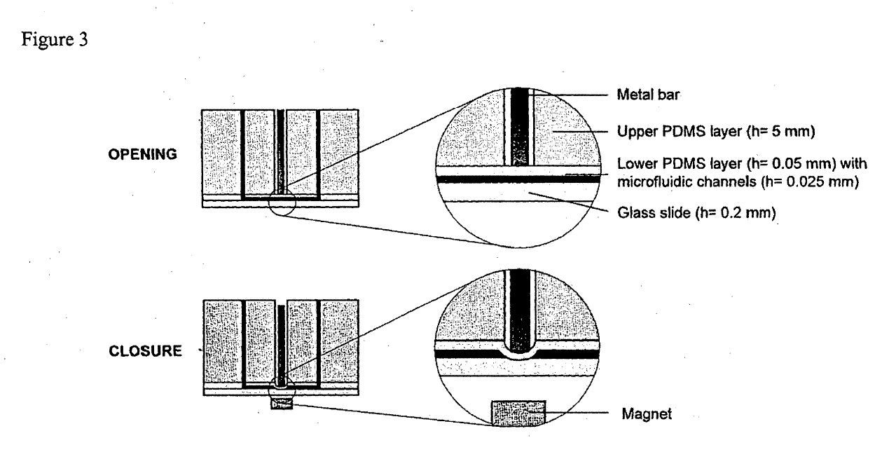

The operation of the magnetically controlled valve is based on deformation of a thin, flexible layer of elastomer that covers the top wall of the microfluidic channel due to the movement of the metal object on one side of the chip caused by a magnet which is placed adjacent to the chip on the opposing side. The metal object may be any shape that can be incorporated into the top layer of the fabricated chip. Suitable metal objects include, but are not limited to cylinders, blocks, rings, discs and spheres, for example. In the presence of a magnet, the metal object is pulled toward the magnet, thereby pushing the thin elastomer membrane downward and closing the entire channel to fluid flow (FIG. 3). In order to open the valve the magnet must be pulled away from the closure position. The magnet may manipulated manually or it may be automated. For example, an electromagnet may be utilized with application of a small amount of voltage.

Factors affecting the operation of the valve to effectively close the microfluid channel include the magnetic field of the magnet, the thickness of the layers of elastomer used for the chip, the height of the channel, and/or the size of the gap between magnet and metal object. The increase of the height of the channel has two opposite effects; the closure of the deeper channel requires more strength from the magnetic valve, yet an increased channel height yields a thinner elastomer layer above the microfluidic channel (supposing chips with patterned layer with the same thickness) that is easier to deflect. Generally, larger channel heights require stronger (and thus larger) magnets. Depending upon these factors, the distance between magnetic valves should be adequate to avoid possible interference of the magnetic fields induced by small magnets.

Suitable magnets include those that are capable of attracting a metal object with enough force to deform the top elastomer layer of the chip. Suitable shapes include, but are not limited to spheres, blocks, discs, rings, and cylinders. In one embodiment, one or more NdFeB magnet(s) are employed. One example of a suitable magnet has the following specifications: dimensions: ⅛″×⅛″× 1/16″; tolerances: ±0.002″×±0.002″×±0.002″; material: NdFeB, Grade N42; plating: Ni-Cu-Ni (Nickel); magnetization direction: thru thickness; weight: 0.00423 oz. (0.120 g); pull force: 1.06 lb.; surface field: 2920 Gauss; Brmax: 13,200 Gauss; BHmax: 42 MGOe. Another example of a suitable magnet has the following specifications: dimensions: 3/16″ diameter; tolerances: ±0.001″; material: NdFeB, Grade N42; plating: Ni-Cu-Ni (Nickel); magnetization direction: axial; weight: 0.0150 oz. (0.424 g); pull force: 0.79 lbs; surface field: 4130 Gauss; Brmax: 13,200 Gauss; BHmax: 42 MGOe. Other suitable magnets are readily apparent to any person having ordinary skill in the art.

When a weaker magnet is used, the thickness of the elastomer layer or support is increased, and/or gap between magnet and chip are increased, the microfluidic channel may be only partially effective. It is envisioned that automation of the operation of the valve using miniaturized, precisely controllable electromagnets instead of permanent magnets would improve performance of the valve. Future applications of the magnetic valve include their use as reversible frits for microcolumns for various micro-chromatography based applications, cell and/or bead-based applications, and in manipulation of minute sample volumes in enzymatic and other chemical reactions.

The proper operation of the magnetically controlled valve is largely due to the high flexibility of the thin layer of elastomer membrane. In the magnetically controlled valve, the deformation of the thin elastomer layer is the key element. In our approach, the deformation depends on the attractive forces between the magnet and the metal object and the rubber-elastic nature (spring constant of the layer) of the thin layer of elastomer.

The metal object of the valve can be considered as a soft ferromagnetic iron core. By inserting a soft ferromagnetic iron core into the magnetic field of the hard permanent magnet, the core becomes polarized and produces an induced magnetic dipole momentum \vec{m}. In an inhomogeneous field the magnitude of the force \vec{F} can be expressed as the product of the magnetic moment and the gradient of the external magnetic field \vec{B} (Eq. 1).

$$F = m \frac{\partial {B}_{x}}{\partial x} \qquad ( 1 )$$

If the direction of \vec{m} and \vec{B} are parallel with the x-axis of the used coordinate system (direction of the bar), according to eq. 2, the acting force (F) increases with an increase in m.

In the case of polymers, a large elastic deformation can be achieved due to the partial orientation of polymer chains. This orientation causes a negative entropy change (ΔS) during the deformation. A detailed statistical analysis of the entropy change leads to the following expression for the elastic strain σ (σ=F/A) in case of small deformations (ε is very small).

$$σ = \frac{ρ RT}{{M}_{c}} ( {( 1 + ɛ )}^{2} - \frac{1}{1 + ɛ} ) ≅ \frac{ρ RT}{{M}_{c}} ( 1 + 2 ɛ - ( 1 - ɛ ) ) = \frac{ρ RT}{{M}_{c}} ( 3 ɛ ) \qquad ( 2 )$$

Here, ρ is the uniaxial stress, R is the molar gas constant, T is the absolute temperature and M_{c} is the molar mass of polymer chain between two adjacent crosslinks, ε is the strain of deformation (the relative length change ε=ΔL/L₀).

### EXAMPLE 1

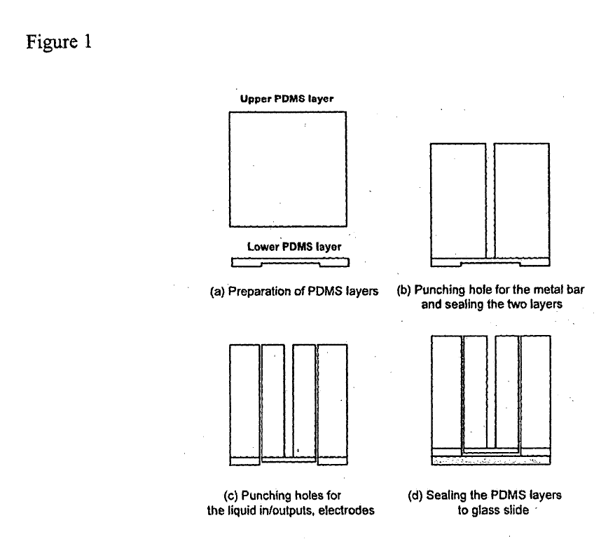

Fabrication of the Elastomeric Layers (FIG. 1a)

A lower PDMS layer containing fluid channels was prepared by using a mold created by photolithography. A pattern of 100 μm wide channels was designed using AutoCAD software (San Rafael, Calif.) and printed as a high resolution (20,000 dpi) photo-mask (CAD/Art Services, Inc., Oreg.). Negative type photoresist (SU-8 2025, Microchem, Newton, Mass.) was spin-coated onto a 3″ silicon wafer at 3000 rpm for 60 s to a thickness of 25 μm. The photoresist coated wafer was baked for 15 min. at 95° C. The pattern on the mask was transferred to the wafer through UV exposure for 2 minutes. The exposed wafer was baked at 95° C. for 5 min and unexposed areas were removed by rinsing with SU-8 developer (Microchem, Newton, Mass.). The elastomer layers with different thicknesses were fabricated by cast molding of a 10:1 mixture of PDMS oligomer and cross-linking agent. The desired thickness (50 μm) of the thin layer containing the microchannel pattern was obtained by spin coating PDMS on to the mold at 1200 rpm for 60 s. The thick layer was prepared by simply pouring the PDMS mixture into a petri dish. Each layer was degassed and baked for 30 min in an oven at 80° C. The PDMS replicas were peeled off from the mold and the petri dish.

Aligning and Sealing the Elastomer Layers (FIG. 1b).

The upper thick layer was punched with hole(s) for the metal object(s). The diameter of the holes was ˜1 mm, slightly larger than the diameter of the objects. It is contemplated that the holes can completely puncture the layer or not, although failure to fully puncture the layer would ultimately result in less attraction between the magnet and the metal object. Alternatively, the upper layer may be fabricated with pre-formed holes (or dimples) via use of a mold. The upper PDMS layer was aligned with the thin lower PDMS layer and sealed irreversibly using an Ar plasma. Holes (300 μm) were punched through the combined PDMS layers for the liquid and electrode connections to the chip (FIG. 1c). The PDMS chip was irreversibly sealed onto a clean cover glass of 150 μm thickness (VWR micro cover glass, VWR, USA) (FIG. 1d).

Actuation of the Valve (FIG. 3).

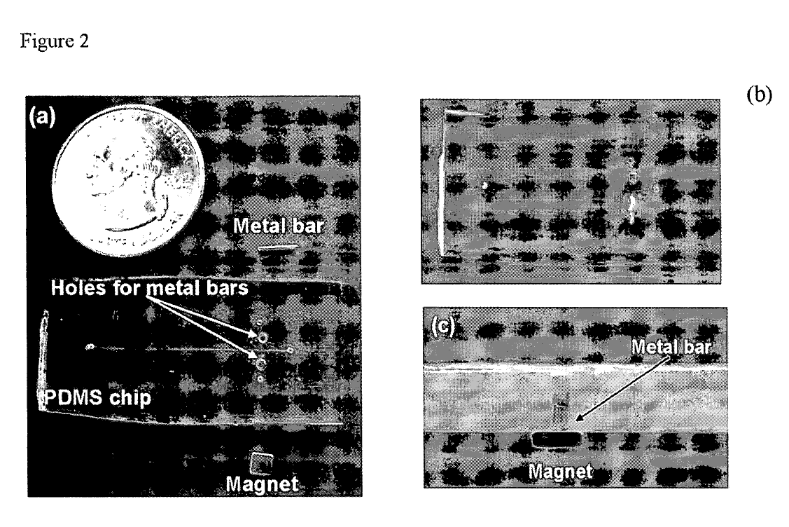

A small, permanent NdFeB magnet (⅛″×⅛″× 1/16″ thick, K&J Magnetics, Inc., Jamison, Pa., USA) was placed below the chip. A cylindrical shaped piece of metal (0.7 mm×5 mm) (paper clip stub) as the metal object (FIG. 2a) was inserted into the valve hole. To actuate the valve, the magnet was moved toward the chip, and the metal bar was attracted toward it from the opposite side (FIGS. 2b& 2c), thereby deforming the flexible layer of PDMS (25 μm) that covered the top of the microfluidic channel (height: 25 μm, width: 100 μm). The entire channel was closed to fluid flow (FIG. 3). To simultaneously actuate more than one valve, a larger magnet can be used. Alternatively, individual magnet/metal object pairs can be used for independent actuation of multiple valves. A peristaltic pump was used to flow liquids at the rates of 0.1-1 μL/min throughout all experiments. The distance between the valves was 4 mm.

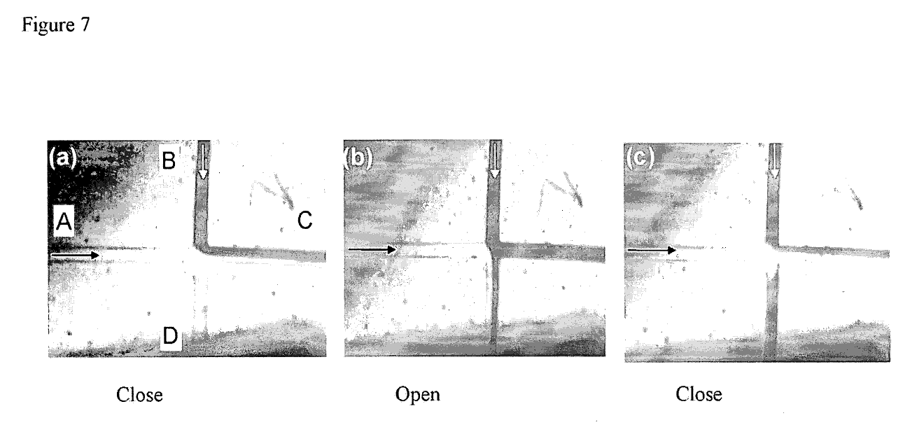

Flow Visualization and Detection (FIG. 7).

For visualization of the valve movement, food dyes (FD&C Blue#1, McCormick&Co., Inc, Md., USA) (0.025 M) were injected and transported by peristaltic pump into the microfluidic channels. The movement of the liquid streams was monitored using an inverted microscope (Nikon Eclipse TE2000-S) equipped with a color CCD camera (Panasonic GP-KR222). Movies and the images were captured by Pinnacle Studio 9 (Mountain View, Calif.) software. The intensities of the RGB colors against pixels on a specified area of the snapshot were determined and evaluated with Imagej 1.37v software (National Institutes of Health, USA). These data were transported to Microsoft Excel program for integration. On the basis of the change of the color intensity the flow rate of dye plug could be determined. In some experiments, after fluid manipulation is accomplished in the chip, the injected dye plugs were detected by UV-Vis (Spectro-100, Thermo Separation, Waltham, Mass., USA) that was connected externally to the chip via a short fused silica capillary of 50 μm ID.

### EXAMPLE 2

Deformation of PDMS Layers by Magnetic Force.

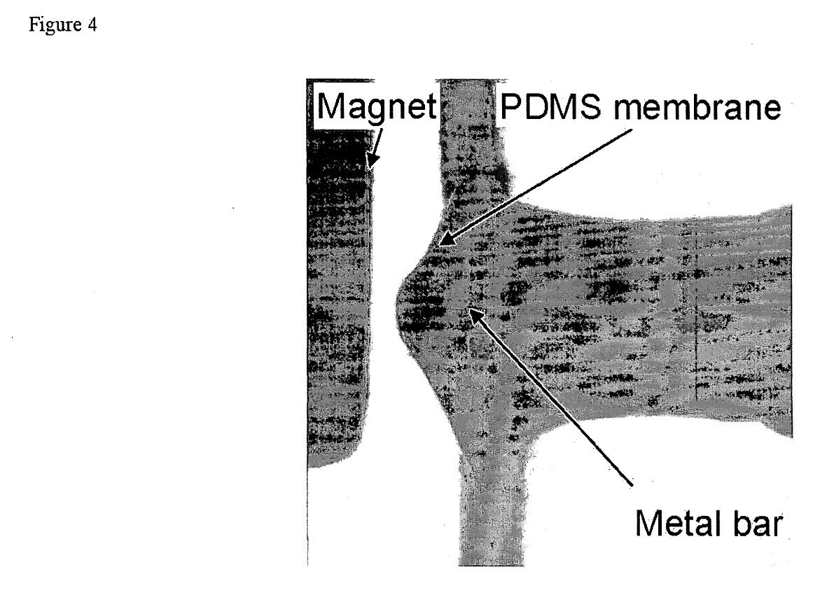

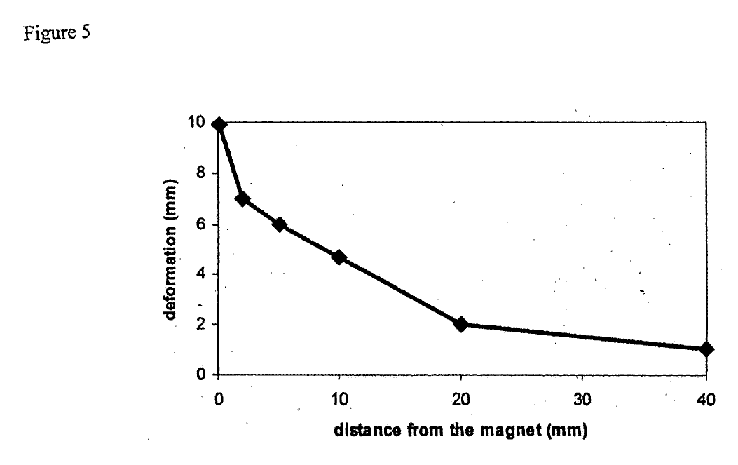

We studied the highest degree of deformation that can be achieved from the permanent magnet. As shown in FIG. 4, a 30 μm thick PDMS membrane was layered onto two vertically placed glass slides spaced 2 mm apart. A metal bar was placed on one side of the membrane and a magnet was gradually brought closer to the membrane from the opposite side. Due to the attractive forces, the metal bar and PDMS membrane is pulled towards the approaching magnet. The movement of the metal bar and membrane are easily visualized under a microscope, and the extent of stretching (deformation) of the membrane can be measured. As the distance between the metal bar and the magnet decreases, the deformation increases due to increased attraction forces between the two objects (FIG. 5). The magnet will be in contact with the metal bar (membrane) when the distance becomes less than 2 mm.

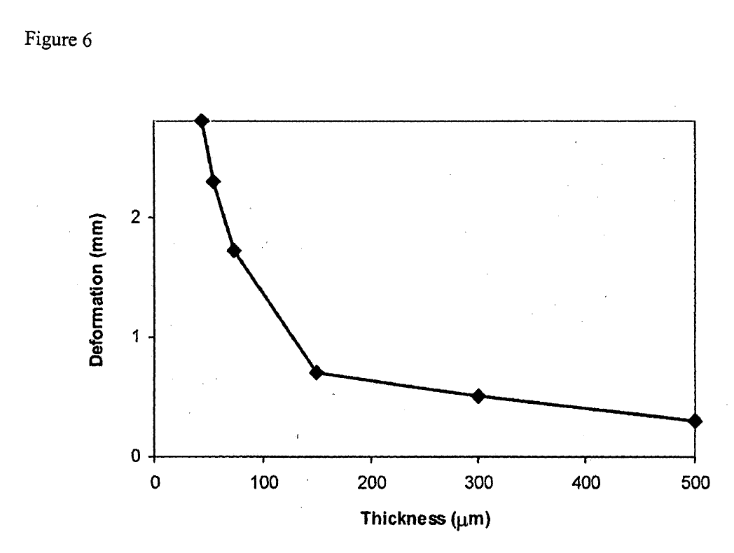

The deformation of the elastomer layer also depends upon its thickness. Layers with different thicknesses can be prepared by spincoating PDMS onto silicon wafers at different spinning speeds. PDMS thickness is inversely proportional to the spinning speed (ω^{0.945}). FIG. 6 shows that the deformation of the layer dramatically increases with a decrease of the thickness below 100 μm. These results demonstrate that a magnetically controlled valve is much more efficient in chips having a thickness of about or less than 50 μm. Hence, the thinner the PDMS layer, the more efficient the valve will be. In practice, we could not peel layers with thickness of smaller than 50 μm from the mold. The 50 μm thickness of the layer is a compromise in order to obtain a thin layer with adequate mechanical stability. It should be understood, however, that automated technology outside of the laboratory setting would enable fabrication of thinner layers.

The degree of deformation of the elastomer layer can be increased by increasing the strength of the magnet. The PDMS layers between the magnet and the metal bar are quite durable. No significant changes in repeated actuations were observed. Earlier studies have reported deflection of PDMS layers with the thickness of 30 μm more than 4 million times without any significant wear or fatigue.

### EXAMPLE 3

Efficiency of Closure of the Valve (Leakage Test).

The operation of the valve and its efficiency in a microfluidic chip was studied using a cross shaped microchannel (FIG. 7). Deionized water was introduced from the left arm (A) of the microchannel and dye was introduced from the top arm (B) at the rate of 0.5 μL/min. The bottom arm (D) contained the magnetically controlled valve (FIG. 7a). When the valve was closed, the laminar flow characteristic in microfluidic systems was observed in the right arm (C). When the valve was opened by moving the magnet 5 mm away from the chip, the dye and water flowed through the valve (FIG. 7b) and the laminar flow was observed in the bottom arm. When the valve was closed, the flow changed the direction towards the right arm where a lower back-pressure exists. It is apparent that dye did not escape through the valve and dispersion of the trapped dye is evident from FIG. 7c, where the bottom arm became uniformly dark 10 min after closure of the valve.

The closure of the valve was also studied in a simple straight channel. The dye was manipulated toward the valve and the magnetic valve was closed before the dye passes the valve. Leakage of the dye could not be observed over the valve at pressure less than 100 kPa applied for 30 min. As the flow rate increased, high pressure built up near the valve and eventually caused the valve to partially or fully collapse. Leakage of solution could be detected by monitoring the decrease in the color intensity of the trapped dye. We observed that flow rates up to 1.7 μL/min (250 kPa) could be used without collapsing the valve. Above this critical value, a slight increase in flow rate could result in significant leakage of the valve. Leakage will not be a major issue, as the flow rates in many microfluidic systems are very low (0.1-1.0 μL/min). Thus, 100% closure can be easily achieved. Increasing the size of the magnet increases the pulling force (1.06 lbs for the used magnets (⅛″×⅛″× 1/16″ thick)), however, the size of the magnet cannot be considerably enlarged when more independent valves are intended to be used on the chip.

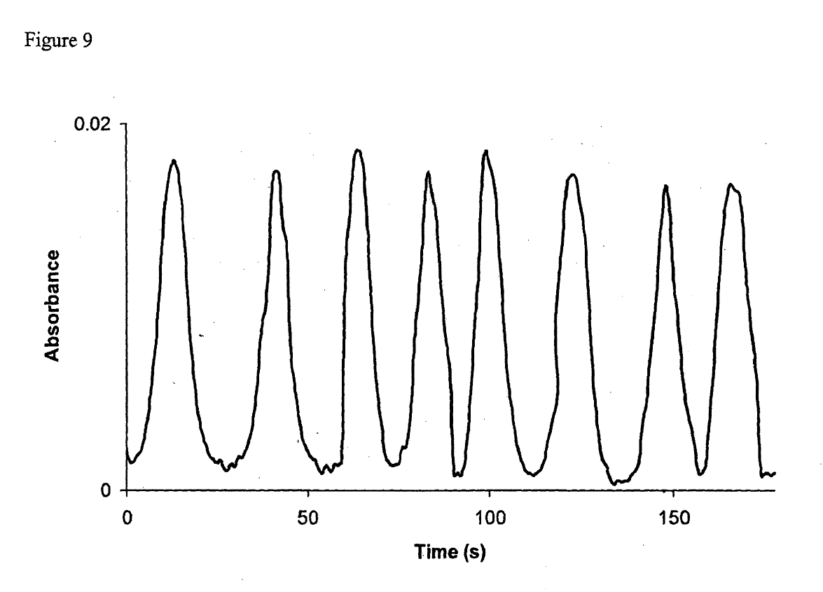

Using a simple cross-shaped microchannel, plugs of dye were injected to a main carrier fluid by closing (100% closure) and opening a valve in time intervals. The size of the plugs can be varied by changing the frequency of valve opening and closure. The obtained dye plugs were detected (410 nm) externally to the chip via a capillary connected to the chip and a spectrophotometer (FIG. 9). The injections were accomplished manually, that is, the magnet was moved back and forth from the chip by hand.

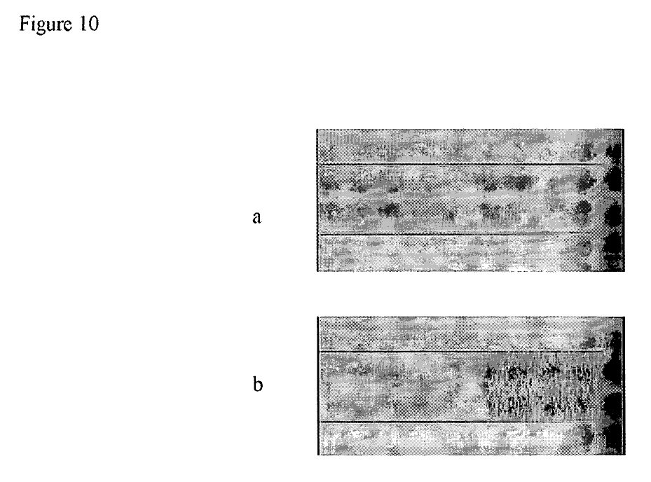

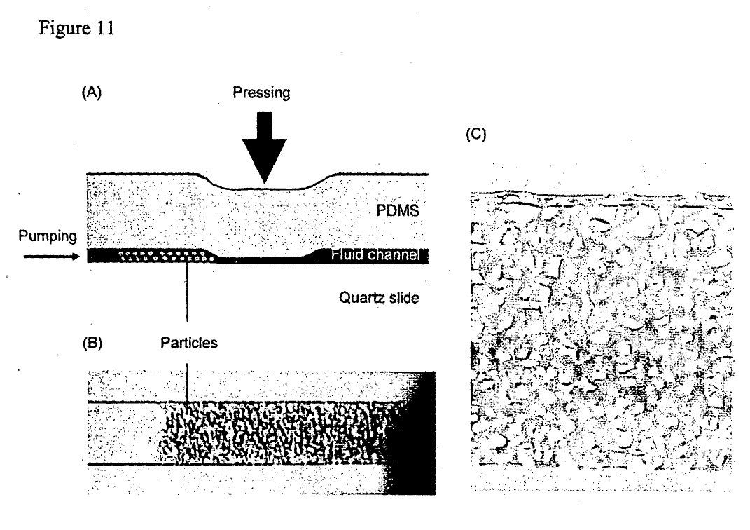

A temporary taper (<100% closure) of the flexible microfluidic channel can easily be achieved by the use of the externally operated magnetic valve (manipulating the magnet toward the metal object causes the metal object to move toward the magnet thereby deforming the PDMS and tapering the fluid channel, FIG. 11A). About 60% taper (closure) was found to be suitable for trapping 10 μm-size particles (C18 chromatographic beads) and thus this taper allows for flow of liquid through the tapered region. FIGS. 10 and 11B show the channel in front of the magnetic valve where the chromatographic beads are trapped. FIG. 11C shows C18 beads packed into a microchannel. These results prove that the magnetic valve is well suited for manipulating liquids and beads in chips. It is apparent that a sophisticated automation system is required to obtain reproducible and reliable operation of the valve especially when repeated injections with exact sample volumes are needed. Automation can be achieved by mechanical instrumentation that is capable of moving the magnet back and forth quickly or by replacing the magnet with an external electromagnet.

### EXAMPLE 4

“Thin Chip” Fabrication.

The PDMS chips were prepared by using a mold created by soft photolithography. The pattern consisting of standard cross-T type channel of 100 μm wide was designed using AutoCAD software (San Rafael, Calif.) and printed as a high resolution (20 000 dpi) photomask (CAD/Art Services, Inc., Bandon, Oreg.). Negative type photoresist (SU-8 2025, Microchem, Newton, Mass.) was spin-coated onto a 3″ silicon wafer at 3000 rpm for 30 s to a thickness of 30 μm. The photoresist coated wafer was baked for 15 min at 95° C. The pattern on the mask was transferred to the wafer through UV exposure for 2 min. The exposed wafer was baked at 95° C. for 5 min and unexposed areas were removed by rinsing with SU-8 developer (Microchem, Newton, Mass.). The PDMS chip was fabricated by cast molding of a 10:1 mixture of PDMS oligomer and cross-linking agent (Sylgard 184, Dow Corning, Midland, Mich.). The PDMS mixture was degassed and baked at 80° C. for 30 min. The PDMS replicas were peeled off from the mold. Holes (300 μm diameter) for the liquid connections were punched through the PDMS chip. At the electrode ports buffer reservoirs made from PDMS were sealed. The chip was irreversibly sealed onto a quartz slide of 0.5 mm thickness (SPI Supplies, West Chester, Pa.).

Fritless Packing of Chip with Chromatographic Particles.

The reversed-phase chromatographic packing material consisted of porous, C18-modified, 10-μm particles (Western Analytical Products, Inc., Wildomar, Calif.). Degassed, filtered (0.45 μm) methanol was used to suspend the chromatographic beads and to prevent them from aggregating before their trapping in the chip. The fritless packing of the chip was based on a temporary, approximate 80% taper of the channel, which trapped all the particles, yet allowed for fluid flow through the tapered region with moderate resistance. The front end of the packing was positioned on the chip by pressing downward on the top of the PDMS chip just above the fluid channel where the chromatographic particles were trapped. In order to temporarily taper the microfluidic channel, the top of the flexible chip was pushed downward (e.g. with a blunt metal rod mounted into a puncher {Technical Innovations, Brazoria, Tex.}) around the point of the channel where the packing began. About 80% taper (closure) was needed to trap the particles and to allow for flow of liquid through the tapered region. A suspension (0.05-0.5 μL) of freshly ultrasonicated, methanolic C18 was manipulated through a small-bore tubing (0.3 mm ID) using a peristaltic pump, and connected to the outlet port and washed with methanol (10 μL/min) for 2 min. A pressure of approximately 2 bar (maximal pressure attainable by the peristaltic pump) was intermittently applied for short periods (4-5 s). After the methanol was rinsed out of the channel with water, the tapering was stopped and methanol and water was pumped through the channel from the reverse direction (inlet port) first moderately, and then with increasing pressure to obtain a smooth front edge of the packing. The packed channel was then rinsed with water and heated at 115° C. overnight to maximize the stability (compactness) of the packing. The packing was washed with methanol at pressure of about 2 bar prior to use.

Sample Injection with Hydrodynamic Pressure in to the Chip

The samples (0.5-5 μL) were introduced into the peristaltic pump tubing (ID: 0.3 mm) which was initially filled with electrolyte. This sample was split in the junction and a small volume of the original sample was manipulated into the separation channel (approximately 0.5-5 nL). For the capillary electrochromatography (CEC) separation, a miniaturized power supply with positive ground was used (0.5-2 kV, Cetox Ltd., Hungary). The analytes injected into the chip were detected by a UV-VIS fiber optic positioned directly on the chip and connected to a miniaturized spectrophotometer (Ocean Optics, USA). The fibers were arranged perpendicular to the microfluidic channel (above and below the chip) using an adjustable stand (x-y translational stage). Since the detection was performed externally, the fiber optics could be positioned at any point along the chip. The PDMS chip with quartz slide could be used for the detection at 265 nm. In case of the liquid chromatography (LC) chip measurement, the above described pressure injection and the transport of the sample through the C18 packing was carried out by a single channel peristaltic pump. Stock solutions of food dyes (FD&C blue#1, FD&C yellow#5 and FD&C red#40, all from McCormick&Co., Inc, Md.) were prepared in water. The buffer electrolyte for the electrophoretic and the electrochromatographic separation contained 50 mM phosphate, pH: 6.8. All solutions (methanol, water) were degassed and filtered through a 0.45 μm syringe filter. A single-channel peristaltic pump was used for the injection.

Initially, a small volume (0.5-5 μL) of solution was manipulated into the peristaltic pump tubing. The sample was subsequently injected at the sample inlet port and was manipulated into the other three channels with different flow rates depending on the hydraulic resistance of each channel. We measured the absorption signals of different volumes of dye solution introduced into the inlet port. The sample plugs are detected before the chromatographic packing. When small plugs (length to width ratio of the plug is smaller than 10; the volume of the plug is smaller than 3 nL) were injected into the separation channel, the dispersion of the solution resulted in reduced signal heights. Larger and constant absorbance values were obtained for sample volumes greater than 3 nL and the areas of the peak increased with increased sample volume. The precision of the injection was almost exclusively determined by the precision of introducing the sample into the pump tubing. In our experiments, the required volume of sample (0.5-5 μL) was “manually” manipulated into the tube and the precision exceeded 2% RSD. Much better repeatability (less than 1% RSD) can be expected using special commercially available microinjectors.

Electrochromatographic Tests

In our earlier work, we described a chip packed with conventional chromatographic particles that provided for facile liquid chromatographic separations. Hence, we suspected that electrochromatographic-based separations on chip would result in greater separation efficiencies due to the flat flow profile induced by electroosmotic flow (EOF) since convective band broadening would be diminished. Within the packing the separation mechanisms of chromatography and electrophoresis are effectively combined. Flow profiles of the moving zones driven by hydraulic pressure and electric field demonstrated the superiority of CEC over conventional LC.

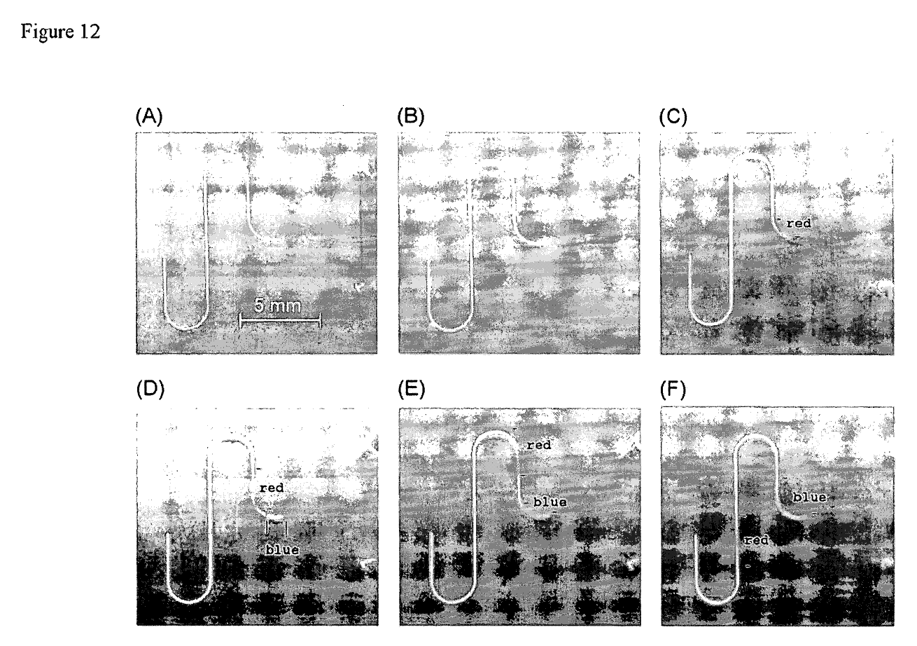

We used a microfluidic channel packed with C18 beads for separation of a mixture of two food dyes (blue and red) in phosphate buffer (50 mM phosphate, pH 6.8) upon application of voltage (750 V). Approximately 5 μL of sample and carrier are continuously pumped from the sample inlet port (FIG. 12A). When the sample plug completely entered into the separation channel, the pumping was stopped and high voltage was applied at the ends of the channel (FIG. 12B). The sample plug was transported to the packing by using high voltage (FIG. 12C), and complete separation could be achieved already in the first 4 mm of the packing (FIG. 12D). The blue dye was retained, while the red dye eluted from the packing (FIGS. 11E, F).

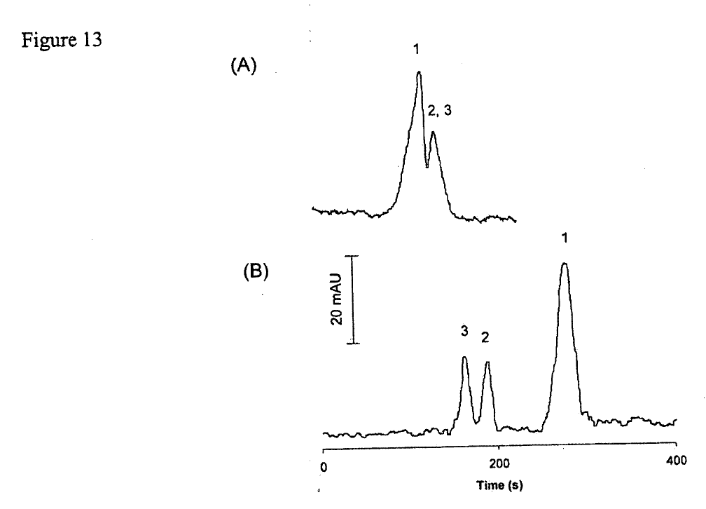

To further test the efficiency of the chromatographic packing in the chip, three cephalosporin antibiotics (ceftriaxon (1), cefazolin (2) and ceftazidim (3), c=10 mg/mL), having relatively similar chemical structures, were injected in phosphate buffer (50 mM phosphate, pH=6.8; methanol content in the carrier fluid does not improve the separation due to the hydrophility of the analytes). When the sample plug was manipulated by pressure through the packing, the three analytes did not completely separate in LC mode. When the same volume of sample was injected and driven by an electric field, the three antibiotics separated and with baseline resolution in CEC mode (FIG. 13A, B). Voltage was 750 V during CEC, flow rate (in the separation channel) was 0.4 nL/s during LC, detection position: 2 mm after the end of the packing, λ=265 nm.

A microfluidic channel packed with C18 beads was used in the separation of a mixture of two food dyes (blue and yellow) in phosphate buffer on application of voltage. The dyes were injected by pressure from the sample inlet port into the separation channel through a cross-T junction and manipulated into the chromatographic packing. Complete separation was achieved within the first 3 mm of packing. The dispersion of the unretained yellow dye was relatively small as it moved through the packing. The blue dye was completely retained on the chromatographic packing even after the yellow dye had eluted from the packing. Although the blue dye may occupy a large area upon adsorption to the chromatographic packing, upon elution with a 50% methanol solution, the dye stacks on the beads and is observed as a sharp peak at the point of detection. Using a phosphate buffer containing 30% methanol, baseline separation of the dyes was achieved.

It should be understood that the foregoing examples are not intended to be limiting and are provided to illustrate just a few of the many embodiments of the invention. The broader spirit of the invention is readily apparent from the following claims.

1. A microfluidic device comprising:
(a) a chip comprising at least two elastomeric layers and a support, wherein
(i) a first elastomeric layer comprises at least one microfluidic channel on its underside, said underside being affixed to a support; and wherein
(ii) a second elastomeric layer comprises at least one valve hole for accepting a metal object,
wherein said second elastomeric layer is affixed to said first elastomeric layer such that said valve hole is positioned opposite said microfluidic channel; and
(b) at least one valve comprising
(i) a magnet adjacent to said chip, wherein said magnet is situated opposite said valve hole and is separated from said valve hole by said support; and
(ii) a metal object, wherein said metal object is situated within said valve hole;
wherein said device is capable of being manipulated such that said magnet and said metal object may be reversibly brought into proximity, whereby at least said first elastomeric layer is depressed by said metal object thereby closing said microfluidic channel.

2. The microfluidic device of claim 1, wherein at least one elastomeric layer comprises polydimethylsiloxane.

3. The microfluidic device of claim 1, wherein said support comprises quartz.

4. The microfluidic device of claim 1, wherein said magnet comprises NdFeB.

5. The microfluidic device of claim 1, wherein said magnet is an electromagnet.

6. The microfluidic device of claim 1, wherein closure of said microfluidic channel is partial.

7. The microfluidic device of claim 1, wherein said magnet is movable.

8. The microfluidic device of clam 1, wherein said chip further comprises at least one hole for accepting at least one liquid connection.

9. The microfluidic device of claim 1, wherein said chip further comprises at least one hole for accepting at least one electrode connection.

10. The microfluidic device of claim 1, wherein said chip is about 100 μm to about 125 μm thick.

11. The microfluidic device of claim 1, further comprising silica particles situated within said at least one microfluidic channel.

12. The microfluidic device of claim 1, further comprising an external detection system.

13. The microfluidic device of claim 12, wherein said external detection system is a fiber optics detection system.
